(19) United States
(12) Patent Application Publication
(10) Pub. No.: US 2012/0154758 A1
(43) Pub. Date: Jun. 21, 2012

(54) PROJECTION DISPLAY DEVICE

(75) Inventors: Shinya Noda, Neyagawa-City (JP); Tsuyoshi Senba, Neyagawa-City (JP); Hideki Iwai, Yamatokoriyama-City (JP)

(73) Assignee: SANYO ELECTRIC CO., LTD., Moriguchi-City (JP)

(21) Appl. No.: 13/324,579

(22) Filed: Dec. 13, 2011

(30) Foreign Application Priority Data
Dec. 16, 2010 (JP) 2010-280648

(51) Int. Cl. G03B 21/20

(52) U.S. Cl. 353/30; 353/119

(57) ABSTRACT

A projection display device includes: a light source part; a light modulating part which modulates light emitted from the light source part; an attachment part to which the light source part is attached; and a power source part which supplies electric power to the light source part. The light source part includes a luminous body and a holder holding the luminous body. The holder is provided with a first connector electrically connected to the luminous body. Meanwhile, the attachment part is provided with a second connector electrically connected to the power source part. In addition, an assist part is provided between the light source part and the attachment part so as to, when the light source part is attached to the attachment part, add a force to the light source part in a direction of attachment and thereby assist connection between the first connector and the second connector.

This application claims priority under 35 U.S.C. Section 119 of Japanese Patent Application No. 2010-280648 filed Dec. 16, 2010, entitled “PROJECTION DISPLAY DEVICE”. The disclosure of the above application is incorporated herein by reference.

### BACKGROUND OF THE INVENTION

1. Field of the Invention

The present invention relates to a projection display device that modulates light from a light source and projects the modulated light onto a projection plane.

2. Disclosure of Related Art

Projection display device (hereinafter, referred to as “projector”) modulates light from a light source by an imager, and projects the modulated light (hereinafter, referred to as “image light”) onto a projection plane. The light source uses a lamp light source, for example.

The lamp light source is formed by a lamp main body and a holder holding the lamp main body, for example. The lamp main body has a luminous tube and a reflector reflecting light from the luminous tube. When the lamp light source enters in the off state due to deterioration over time or damage, the lamp light source needs to be replaced. Accordingly, the lamp light source is detachably attached in the projector main body so as to be capable of being replaced.

The luminous tube is supplied electric power from a power source part provided in the projector main body. To supply electric power to the luminous tube, the holder may be provided with a connector electrically connected to the luminous tube, for example. When the lamp light source is attached in the projector main body, the connector of the holder is connected to a connector of the projector main body which is electrically connected to the power source part. Accordingly, electric power from the power source part is supplied to the luminous tube via the two connectors.

In the foregoing configuration, when the light source lamp is attached in the projector main body, if the two connectors are not fully connected but are partially connected, there is a fear that electric power cannot be favorably supplied to the luminous tube.

### SUMMARY OF THE INVENTION

A projection display device according to a main aspect of the present invention includes: a light source part; a light modulating part which modulates light emitted from the light source part; an attachment part to which the light source part is attached; and a power source part which supplies electric power to the light source part. The light source part includes a luminous body and a holder holding the luminous body. The holder is provided with a first connector electrically connected to the luminous body. Meanwhile, the attachment part is provided with a second connector electrically connected to the power source part. In addition, an assist part is provided between the light source part and the attachment part so as to, when the light source part is attached to the attachment part, add a force to the light source part in a direction of attachment and thereby assist connection between the first connector and the second connector.

### BRIEF DESCRIPTION OF THE DRAWINGS

These and other objects, and novel features of the present invention will become more apparent upon reading the following detailed description of the embodiment along with the accompanying drawings.

FIG. 1 is a diagram showing an outer configuration of a projector in an embodiment of the present invention;

FIG. 2 is a diagram showing an inner structure of the projector in the embodiment;

FIG. 3 is a diagram showing a configuration of an optical system in the embodiment;

FIG. 4 is a diagram showing a configuration of a light source device in the embodiment;

FIG. 5 is a diagram showing a configuration of the light source device in the embodiment;

FIGS. 6A and 6B are diagrams showing a configuration of a light source device in the embodiment;

FIGS. 7A and 7B are diagrams showing a configuration of a lamp unit in the embodiment;

FIG. 8 is a diagram showing a configuration of the lamp unit in the projector in the embodiment;

FIGS. 9A and 9B are cross-sectional views of major components of the light source device in which the lamp unit is being attached in a lamp storage part in the embodiment;

FIGS. 10A and 10B are diagrams for describing advantages of the embodiment; and

FIGS. 11A and 11B are diagrams showing a configuration of a light source device in a modification example.

However, the drawings are intended only for illustration, but do not limit the scope of the present invention.

### DESCRIPTION OF PREFERRED EMBODIMENTS

A projector in an embodiment of the present invention will be described below with reference to the drawings.

In this embodiment, a first lamp power source unit 13 and a second lamp power source unit 14 are equivalent to a “power source part” recited in the claims; liquid crystal panels 102, 103, and 104 are equivalent to an “light modulating part” recited in the claims; lamp storage parts 212 are equivalent to an “attachment part” recited in the claims; mirror members 220 are equivalent to a “light combination part” recited in the claims; lamp units 300 are equivalent to a “light source part” recited in the claims; luminous tubes 311 are equivalent to a “luminous body” recited in the claims; and lamp holders 320 are equivalent to a “holder” recited in the claims. First projection parts 327, plate springs 260, and second projection parts 262, constitute an “assist part” recited in the claims. The foregoing correspondences in description between the claims and this embodiment are merely examples, and do not limit the claims to this embodiment.

### <Entire Configuration of the Projector>

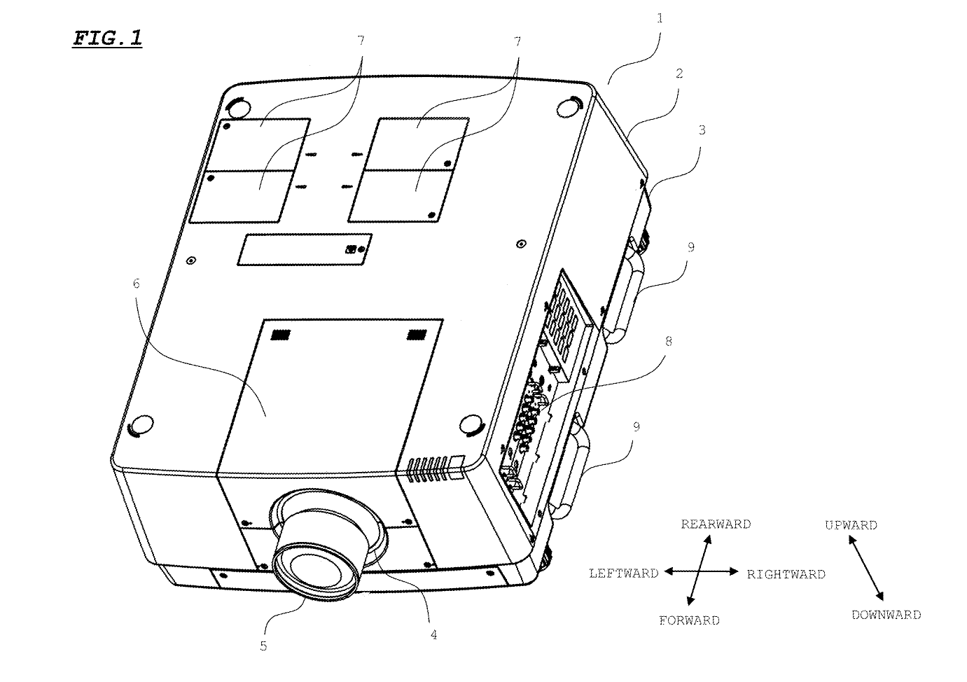

FIG. 1 is a diagram showing an outer configuration of the projector. The projector in this embodiment is a so-called, four-lamp type large-sized projector including four lamp units.

Referring to FIG. 1, the projector includes a main body cabinet 1 having the shape of an approximately rectangular parallelepiped. The main body cabinet 1 is configured to have a lower cabinet 2 and an upper cabinet 3 laid on the lower cabinet 2 from above.

The upper cabinet 3 has a projection window 4 at a center of a front surface thereof, and a front surface of the projection lens 5 is exposed outward through the projection window 4.

In addition, the upper cabinet 3 has a main cover 6 covering a main opening from the front to upper surfaces thereof. The main opening is provided for replacement of the projection lens 5 and a prism unit, and for adjustment of a polarizer and the like. The upper cabinet 3 has four lamp covers 7 covering four lamp openings at a rear portion of the upper surface thereof. The lamp openings are provided for replacement of the lamp units.

Further, the upper cabinet 3 has an input/output terminal part 8 on a right side surface thereof. The input/output terminal part 8 has various AV terminals through which audio visual (AV) signals are input.

The lower cabinet 2 has two each handles 9 on right and left side surfaces thereof. The handles 9 are used for carrying the projector.

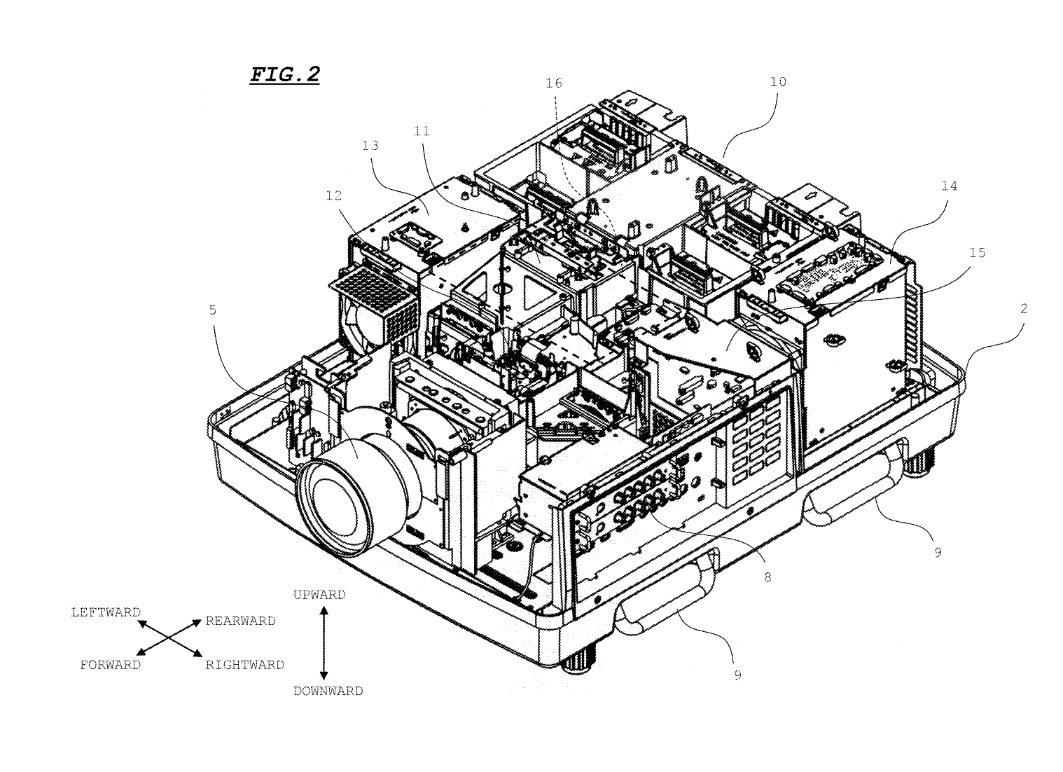

FIG. 2 is a diagram showing an inner structure of the projector with the upper cabinet 3 removed.

Referring to FIG. 2, the lower cabinet 2 contains a light source device 10, and an optical system 11 which modulates light emitted from the light source device 10 and generates image light.

The light source device 10 is disposed at a rear portion of the lower cabinet 2. The optical system 11 is disposed in front of the light source device 10. The optical system 11 has a prism unit 12 in such a manner as to be capable of being attached or detached from above. Detailed configurations of the light source device 10 and the optical system 11 will be described later.

The projection lens 5 is disposed in front of the optical system 11. The projection lens 5 enlarges image light generated by the optical system 11 and projects the same onto a projection plane such as a screen or the like.

A first lamp power source unit 13 is disposed on a left side of the optical system 11, and a second lamp power source unit 14 is disposed on a right side of the light source device 10. The first lamp power source unit 13 includes two lamp power source parts which supply electric power to the two front and rear lamp units on the left side of the light source device 10. The second lamp power source unit 14 includes two lamp power source parts which supply electric power to the two front and rear lamp units on the right side of the light source device 10. In addition, a main power source unit 15 is disposed in front of the second lamp power source unit 14. The main power source unit 15 supplies electric power to electric components (liquid crystal panels and the like) constituting the optical system 11, a control board 16, and the like.

The control board 16 is disposed above the optical system 11. The control board 16 includes a control circuit for controlling electric components such as the liquid crystal panels, the lamp units, and the like. In FIG. 2, the control board 16 is shown by broken lines to make the optical system 11 see-through.

### <Configuration of the Optical System>

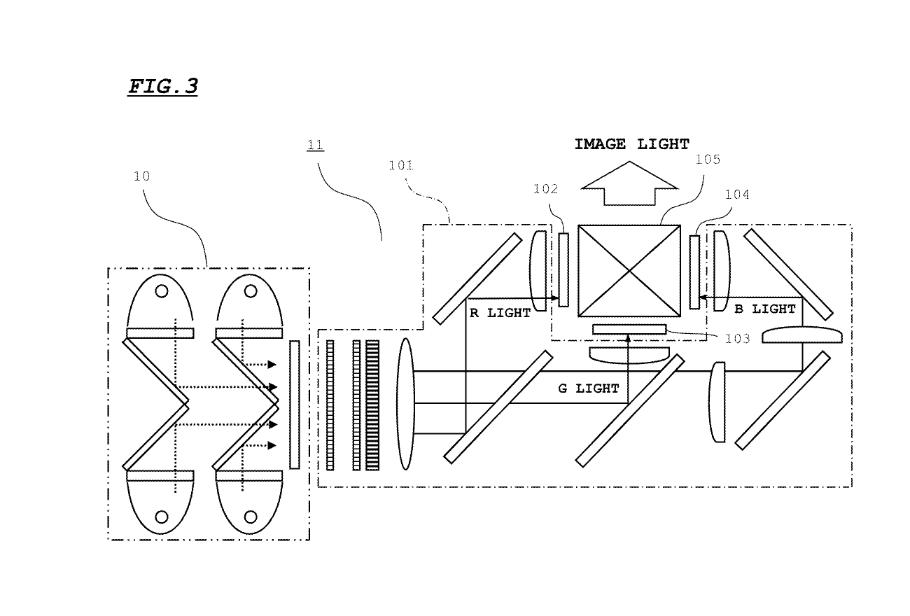

FIG. 3 is a diagram showing a configuration of the optical system 11.

As shown in FIG. 3, the optical system 11 includes a light-guiding optical system 101, three transmissive liquid crystal panels 102, 103, and 104, and a dichroic prism 105. The liquid crystal panels 102, 103, and 104 have polarizers not shown at incident and output sides.

White light emitted from the light source device 10 enters the light-guiding optical system 101. The light-guiding optical system 101 includes a fly-eye integrator, a PBS array, a condenser lens, a dichroic mirror, a plane mirror, a relay lens, and the like. The white light having entered the light-guiding optical system 101 is separated into a light of a red wavelength band (hereinafter, referred to as “R light”), a light of a green wavelength band (hereinafter, referred to as “G light”), and a light of a blue wavelength band (hereinafter, referred to as “B light”), and the separated lights are irradiated to the liquid crystal panels 102, 103, and 104. The R, G, and B lights modulated by the liquid crystal panels 102, 103, and 104 are combined by the dichroic prism 105, and are emitted as image light. The liquid crystal panels 102, 103, and 104 and the dichroic prism 105 are integrated to constitute the prism unit 12.

Instead of the transmissive liquid crystal panels 102, 103, and 104, imagers forming the optical system 11 may use reflective liquid crystal panels or MEMS devices. In addition, the optical system 11 may not be a three-plate optical system including three imagers as described above, but may be a single-plate optical system using one imager and a color wheel, for example.

### <Configuration of the Light Source Device>

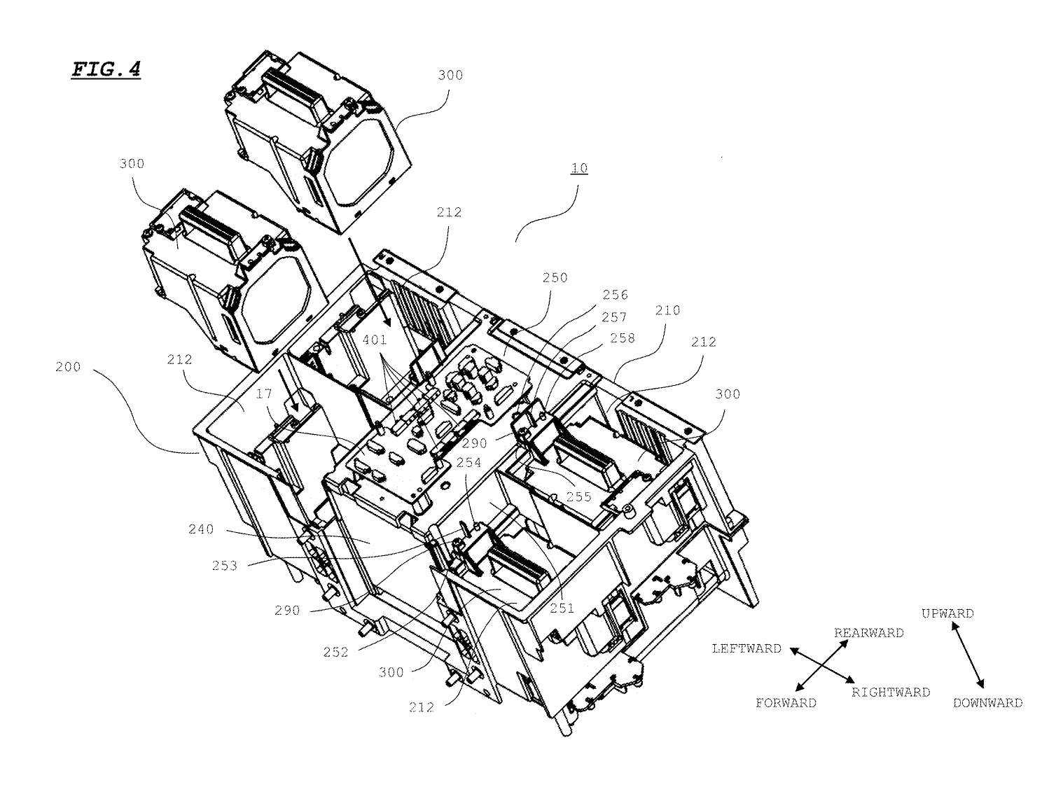

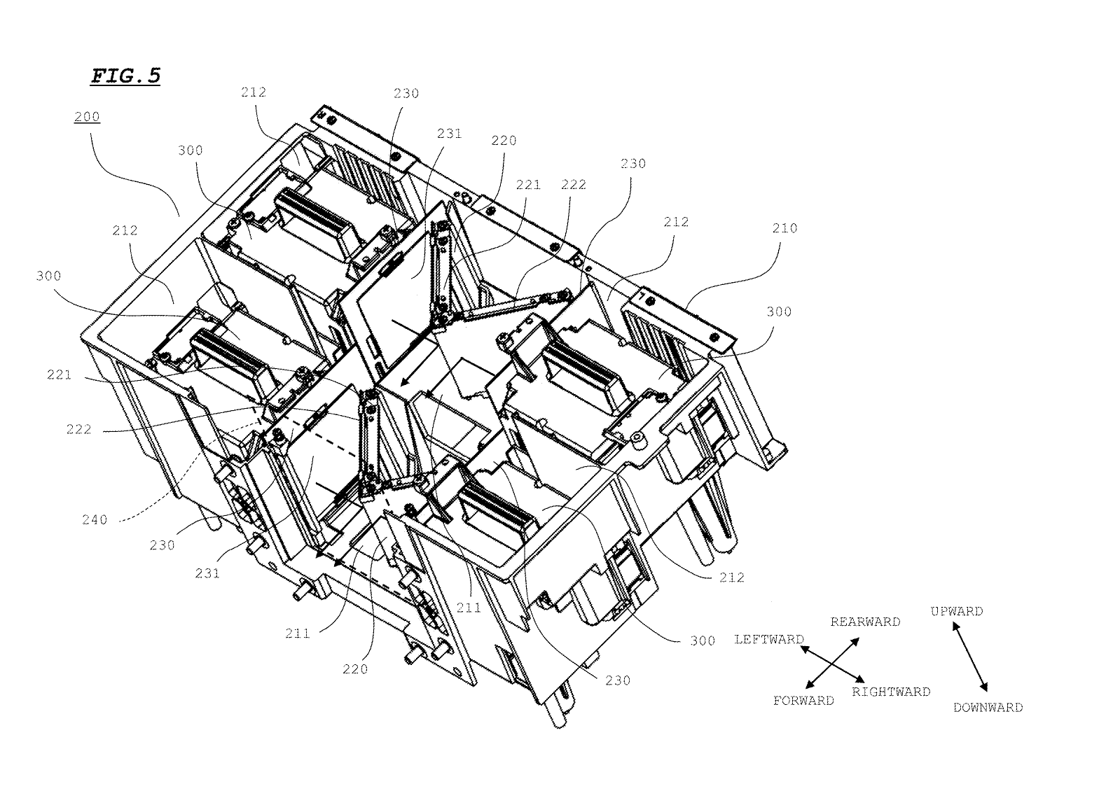

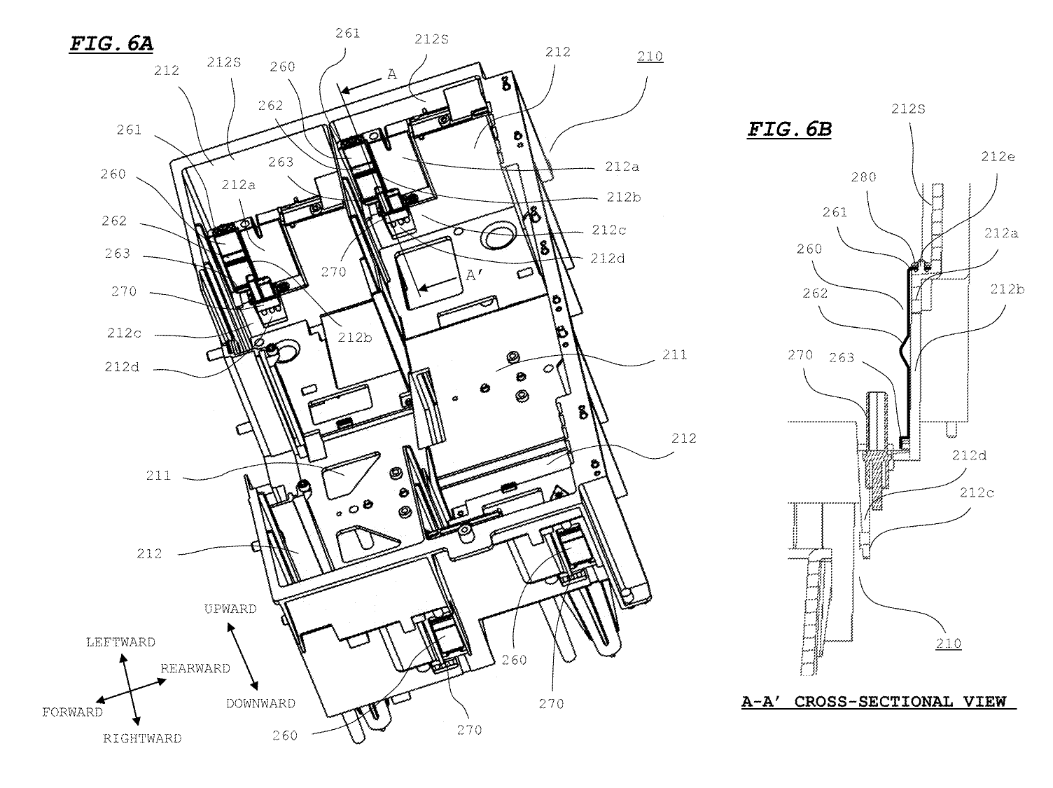

FIGS. 4 to 6 are diagrams showing a configuration of the light source device 10. FIG. 4 is a perpendicular view of a lamp attachment unit 200 from which two lamp units 300 are removed. FIG. 5 is a perpendicular view of the lamp attachment unit 200 from which a mirror cover 250 is removed. In addition, FIGS. 6A and 6B are diagrams showing a configuration of a housing 210. FIG. 6A is a perpendicular view, and FIG. 65 is a cross-sectional view of FIG. 6A taken along line A-A′.

Referring to FIGS. 4 to 6, the light source device 10 is formed by the lamp attachment unit 200 fixed to the lower cabinet 2, and four lamp units 300 attached to the lamp attachment unit 200.

The lamp attachment unit 200 includes a housing 210, two mirror members 220, four first UV-cutoff members 230, a second UV-cutoff member 240, and a mirror cover 250.

The housing 210 is made of a resin material, and has two mirror placement parts 211 disposed at a center thereof and four lamp storage parts 212 formed on both sides of the mirror placement parts 211. The front-side mirror placement part 211 has a bottom surface lower than a bottom surface of the rear-side mirror placement part 211. in addition, the two front-side right and left lamp storage parts 212 have bottom surfaces lower than bottom surfaces of the two rear-side right and left lamp storage parts 212. The mirror members 220 are placed at the mirror placement parts 211. The lamp units 300 are attached in the lamp storage parts 212.

The mirror members 220 include V-shaped base members 221, and V-shaped plane mirrors 222 attached to front surfaces of the base members 221. The mirror members 220 reflect light emitted from the lamp units 300 and guide the same forward.

The first UV-cutoff members 230 include UV-cutoff glasses 231 for blocking passage of ultraviolet rays. The first UV-cutoff members 230 are positioned between the lamp storage parts 212 and the corresponding mirror placement parts 211.

The second UV-cutoff members 240 are UV-cutoff glasses for blocking passage of ultraviolet rays, which are disposed in front of the front mirror placement parts 211. The second UV-cutoff members 240 are set higher than a path of the light reflected by the rear mirror member 220 and traveling forward.

The mirror cover 250 covers upper sides of the mirror placement parts 211. The mirror cover 250 has side parts 251 on right and left of a front side thereof, which extend down to upper ends of the first UV-cutoff members 230. The side parts 251 have receiving portions 252. When the lamp units 300 are attached in the lamp storage parts 212, the receiving portions 252 receive flange portions 326a of the lamp units 300. The receiving portions 252 have guide ribs 253 extending upward therefrom and positioning pins 254 projecting therefrom. The mirror cover 250 also has receiving portions 255 on right and left of a rear side thereof. The receiving portions 255 have guide plates 256 extending upward therefrom and guide ribs 257 formed on the guide plates 256. The receiving portions 255 also have positioning pins 258.

A sub board 17 is placed on an upper surface of the mirror cover 250. The sub board 17 is provided with detection switches 401 for detecting opening/closing of the lamp covers 7. The detection switches 401 use micro-switches, for example. The detection switches 401 are disposed in correspondence with the lamp covers 7. When any of the lamp covers 7 is opened, the detection switch 401 turns from a closed state to an opened state, for example. Accordingly, a detection signal indicating opening of the lamp cover 7 is input into the control board 16.

As shown in FIGS. 6A and 6B, at the lamp storage parts 212, upper mount portions 212a extending inward are formed on side surfaces 212S opposite to the mirror placement portions 211. The upper mount portions 212a have opening portions 212b to which the plate springs 260 are attached. Lower mount portions 212c are formed under the upper mount portions 212a so as to extend more inward than the upper mount portions 212a. The lower mount portions 212c have opening portions 212d to which second connectors (receptacles) 270 are attached.

Since the front lamp storage parts 212 have bottom surfaces lower than those of the rear lamp storage parts 212, the upper mount portions 212a and the lower mount portions 212c of the front lamp storage parts 212 are located lower than the upper mount portions 212a and the lower mount portions 212c of the rear lamp storage parts 212.

The plate springs 260 are formed by bending metal plates. As shown in FIG. 6B, upper end portions 261 of the plate springs 260 are bended rearward at an appropriately right angle. The upper end portions 261 are tentatively fastened by positioning pins 212e, and then are fixed by screws 280 on the upper surfaces of the upper mount portions 212a. In addition, second projection parts 262 are formed at an appropriately center of the plate springs 260. Second projection parts 262 are formed in a triangle shape as seen from the side. Further, lower end portions 264 of the plate springs 260 are bended in inversed L shape. The lower end portions 264 are engaged at lower edge portions of the opening portions 212b. Accordingly, the lower end portions 264 are not moved outward even if the second projection parts 262 are pressed outward.

The second connectors 270 are electrically connected to the first lamp power source unit 13 and the second lamp power source unit 14 via cables (lead wires) not shown.

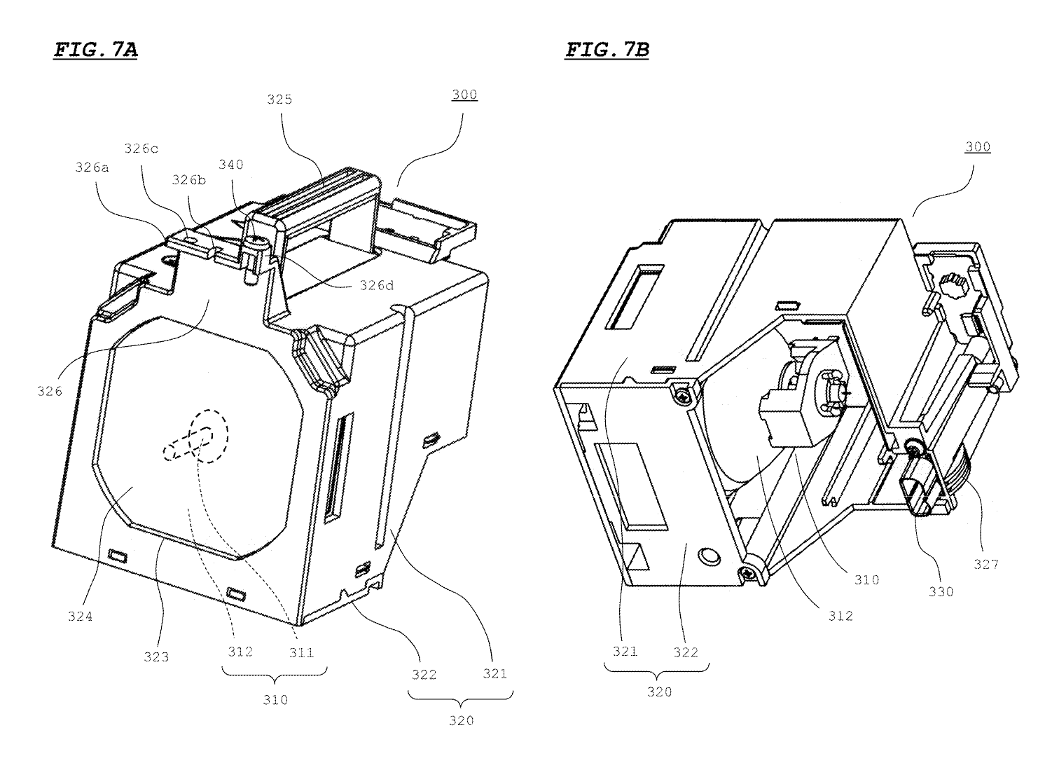

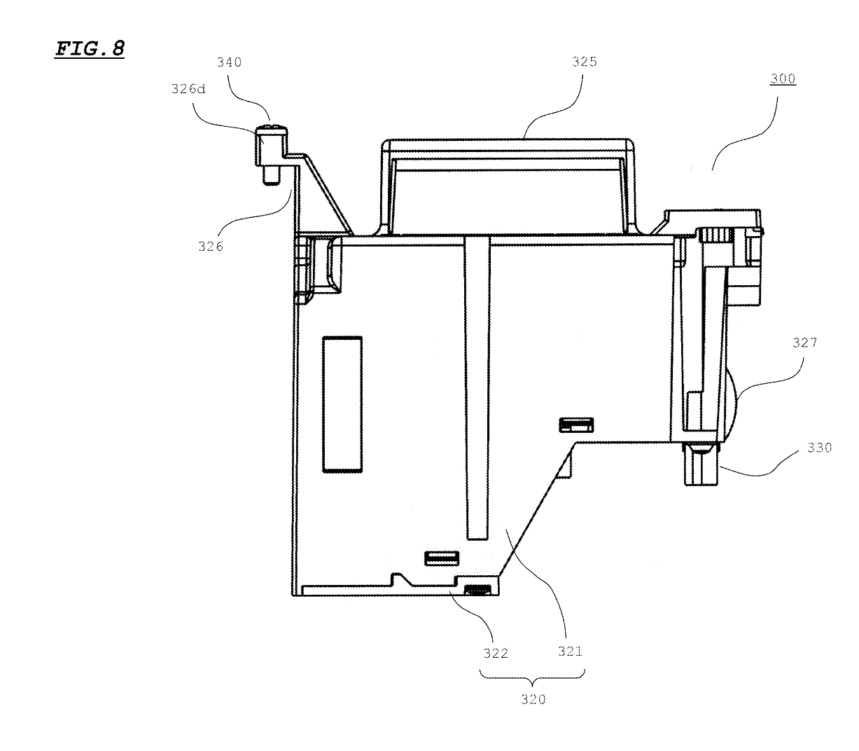

FIGS. 7A, 7B, and 8 are diagrams showing a configuration of the lamp unit 300. FIG. 7A is a perpendicular view of the lamp unit 300 seen from a front oblique direction. FIG. 7B is a perpendicular view of the lamp unit 300 seen from a rear oblique direction. FIG. 8 is a side view of the lamp unit 300.

Referring to FIGS. 7A, 7B and 8, the lamp unit 300 is configured to have a lamp 310 and a lamp holder 320 holding the lamp 310. The lamp 310 includes a luminous tube 311 emitting white light and a reflector 312 reflecting white light emitted from the luminous tube 311. The lamp 310 uses an ultrahigh pressure mercury lamp, a xenon lamp, or the like, for example.

The lamp holder 320 is made of a resin material, and includes a holder main body 321 and a bottom plate 322. The holder main body 321 has on a front surface thereof an output window 323 through which light from the lamp 310 is emitted. A heat-resistance glass plate 324 is fitted into the output window 323. The holder main body 321 has an open bottom surface through which the lamp 310 is attached from underneath. The bottom plate 322 is attached to a front half of the bottom surface of the holder main body 321, thereby supporting the lamp 310 at a bottom thereof.

The holder main body 321 has a handle 325 on a top surface thereof. The handle 325 is used to carry the lamp unit 300 and attach or detach the lamp unit 300 to or from the lamp attachment unit 200. The holder main body 321 has a lamp fixing part 326 in front of the handle 325. The lamp fixing part 326 includes a flange portion 326a formed at an upper end thereof. The flange portion 326a has a guide groove 326b, a positioning hole 326c, and a screw hole portion 326d. A screw 340 is inserted into the screw hole portion 326d.

The holder main body 321 has a first projection part 327 on a rear surface thereof. The first projection part 327 is formed in the shape of an arc as seen from a side.

A first connector 330 is mounted under the first projection part 327. The first connector (plug) 330 is electrically connected to the luminous tube 311 via a cable (lead wire) not shown.

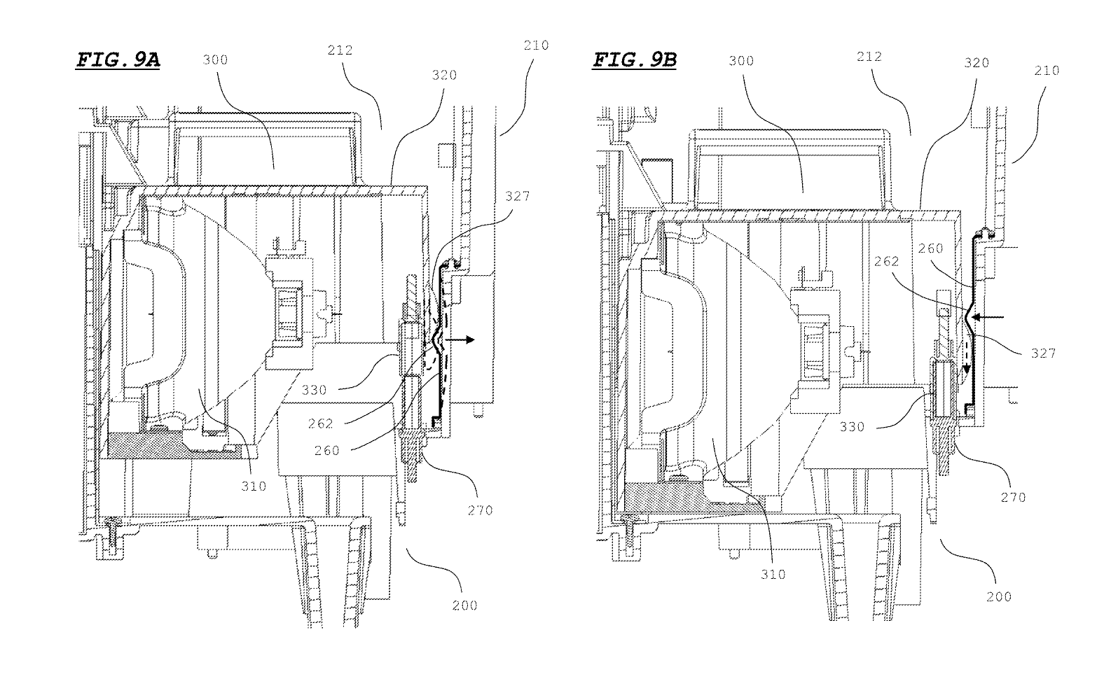

FIGS. 9A and 9B are cross-sectional views of major components of the light source device 10 in which the lamp unit 300 is attached in the lamp storage part 212. FIG. 9A shows the state of the first connector 330 immediately before being connected to the second connector 270. FIG. 9B shows the state of the first connector 330 fully connected to the second connector 270.

The lamp unit 300 is inserted into the lamp storage part 212 such that a front side thereof (output window 323 side) faces the mirror placement part 211. At that time, the guide groove 326b of the flange part 326a is aligned with the guide rib 253 (257) of the mirror cover 250.

When the lamp unit 300 is inserted near the bottom surface of the lamp storage part 212, the first projection part 327 of the lamp holder 320 contacts the second projection part 262 of the plate spring 260 fixed to the lamp storage part 212, as shown in FIG. 9A. At that time, the first connector 330 is in a state immediately before being connected to the second connector 270.

In this state, when the lamp unit 300 is further pressed down and the first projection part 327 is moved downward as shown by a broken line in FIG. 9A, the second projection part 262 moves in a direction of departing from the lamp unit 300 (direction shown by a solid arrow in FIG. 9A) along the arc shape of the first projection part 327 by an elastic effect of the plate spring 260. Then, when a peak portion of the first projection part 327 goes over a peak portion of the second projection part 262, the second projection part 262 moves in a direction toward the lamp unit 300 (in a direction shown by a solid arrow in FIG. 9B) by an elastic force of the plate spring 260. At that time, a downward assist force (shown by a dashed arrow in FIG. 9B) acts on the first projection part 327. By the effect of the assist force, the lamp unit 300 can smoothly be attached in the lamp storage part 212, whereby the first connector 330 is fully connected to the second connector 270. This allows power supply from the first lamp power source unit 13 and the second lamp power source unit 14 to the luminous tubes 311 of the lamp units 300. Then, the plate spring 260 returns to the original state in which the upper side of the first projection part 327 comes close to the lower side of the second projection part 262. Accordingly, even if any upward force is applied to the lamp unit 300 by some factor, the lamp unit 300 is less prone to move upward and the first connector 330 and the second connector 270 are unlikely to be disengaged from each other.

As in the foregoing, the first projection part 327 and the second projection part 262 are in a positional relationship in which the second projection part 262 is not pressed by the first projection part 327 when the first connector 330 and the second connector 270 are not yet connected, and the second projection part 262 is pressed by the first projection part 327 and returns to the original position when the first connector 330 and the second connector 270 are fully connected. More desirably, the first projection part 327 and the second projection part 262 are in a positional relationship in which, when the second projection part 262 returns to the original position, the first projection part 327 and the second projection part 262 come close to each other. In addition, the first projection part 327 and the second projection part 262 may contact each other.

When the lamp units 300 are fully attached to the lamp storage parts 212, the flange portions 326a of the lamp units 300 contact the receiving portions 252 (255) of the mirror cover 250, and the positioning pins 254 (258) are fitted into the positioning holes 326c of the flange portions 326a. The flange portions 326a are fixed to the receiving parts 252 (255) by the screws 340 inserted into the screw hole portions 326d (see FIG. 4). Accordingly, the lamp units 300 are fixed to the lamp attachment units 200.

When the four lamp units 300 are assembled into the lamp attachment units 200, the two right and left lamp units 300 are opposite to each other with the mirror member 220 therebetween. When the projector starts operation, as shown in FIG. 5, light emitted from the lamp units 300 passes through the corresponding first UV-cutout members 230 while being cleared of ultraviolet rays. Then, the light having passed through the first UV-cutoff members 230 is reflected by the mirror members 220 corresponding to the lamp units 300 and is combined into one light, and then the combined light travels forward. In this arrangement, the two front lamp units 300 are positioned lower than the two rear lamp units 300. Therefore, the light from the rear lamp units 300 is not blocked by the front lamp units 300. The combined light then passes through the second UV-cutoff members 240 while being further cleared of ultraviolet rays. As in the foregoing, since the light from the four lamp units 300 is combined, the light source device 10 emits high-intensity light.

### EFFECTS OF THIS EMBODIMENT

As in the foregoing, according to this embodiment, when the lamp units 300 are attached to the lamp attachment units 200, the assist mechanisms constituted by the first projection parts 327 of the lamp holders 320 and the second projection parts 262 of the plate springs 260 apply forces to the lamp units 300 in the direction of attachment. Accordingly, the first connectors 330 can smoothly be connected to the second connectors 270, thereby suppressing connection failure between the first connectors 330 and the second connectors 270.

In addition, according to this embodiment, the second projection parts 262 are formed at plate springs 260, thereby to allow the second projection parts 262 to favorably be held in an elastic manner.

Further, according to this embodiment, the second projection parts 262 are formed at plate springs 260 on the lamp attachment unit 200 side. That is, the plate springs 260 are provided on the lamp attachment units 200 side in the main body cabinet 1. Accordingly, there is no fear that, when the lamp units 300 are carried, the plate springs 260 are deformed due to contact with something, unlike in the case where the plate springs 260 are provided on the lamp unit 300 side.

Moreover, according to this embodiment, the first projection parts 327 are formed in the shape of an arc, and the second projection parts 262 move along the arc shape of the first projection parts 327, whereby the second projection parts 262 can easily move in a direction of departing from the lamp units 300. Accordingly, the first projection parts 327 can go over the second projection parts 262 by applying an appropriate force, whereby the lamp units 300 can smoothly be attached to the lamp attachment units 200.

In addition, according to this embodiment, a plurality of lamp units 300 is used and light from the lamp units 300 is combined, thereby achieving high intensity. When a plurality of lamp units 300 is provided, there is a higher probability that connection failure occurs between the first connectors 330 and the second connectors 270. However, according to this embodiment, it is possible to reduce a probability of connection failure between the first connectors 330 and the second connectors 270 even if a plurality of lamp units 300 is used.

Further, according to this embodiment, the second projection parts 262 (plate springs 260) are positioned near the second connectors 270, it is possible to allow an assist force to act near the second connectors 270, whereby the first connectors 330 and the second connectors 270 can be more smoothly connected.

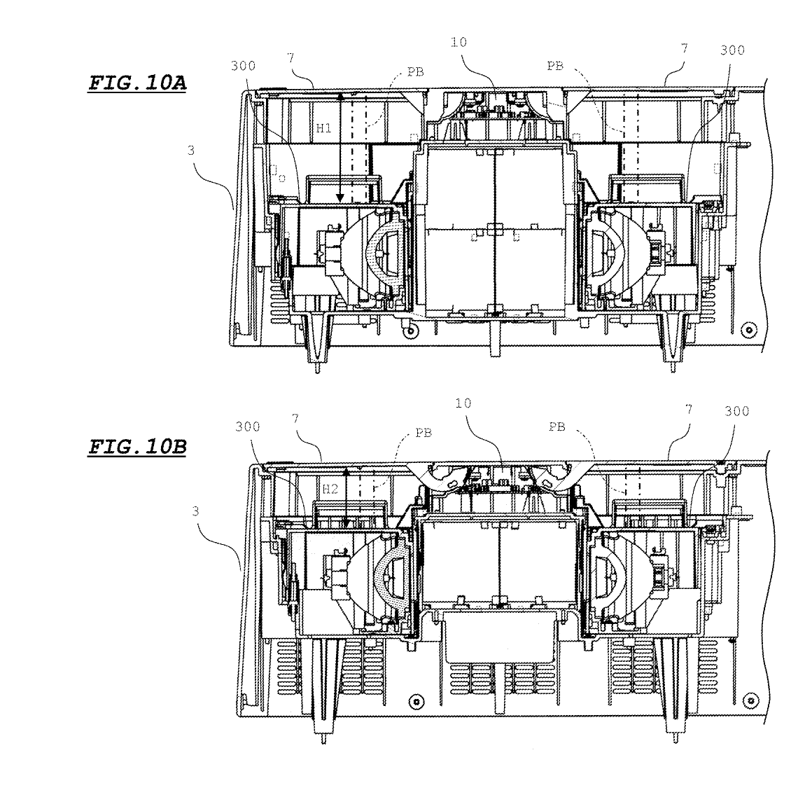

Moreover, as in this embodiment, when the front lamp units 300 are positioned lower than the rear lamp units 300 such that light from the rear lamp units 300 is not blocked, a height H1 between the front lamp units 300 and the corresponding lamp covers 7 is different from a height H2 between the rear lamp units 300 and the corresponding lamp covers 7, as shown in FIGS. 10A and 10B. To press the lamp units 300 in the direction of attachment, press bar parts FB may be formed so as to extend from the back surfaces of the lamp covers 7 toward the lamp units 300, as shown by dashed lines in FIGS. 10A and 10B. In this case, however, the press bar parts FB have different lengths at the front lamp covers 7 and the rear lamp covers 7, and therefore the four lamp covers 7 cannot be configured as common components.

In this respect, according to this embodiment, all the four lamp covers 7 can be configured as common components.

### Others

Although an embodiment of the present invention is as described above, the present invention is not limited to this embodiment. in addition, the embodiment of the present invention can further be modified in various manners besides the foregoing ones.

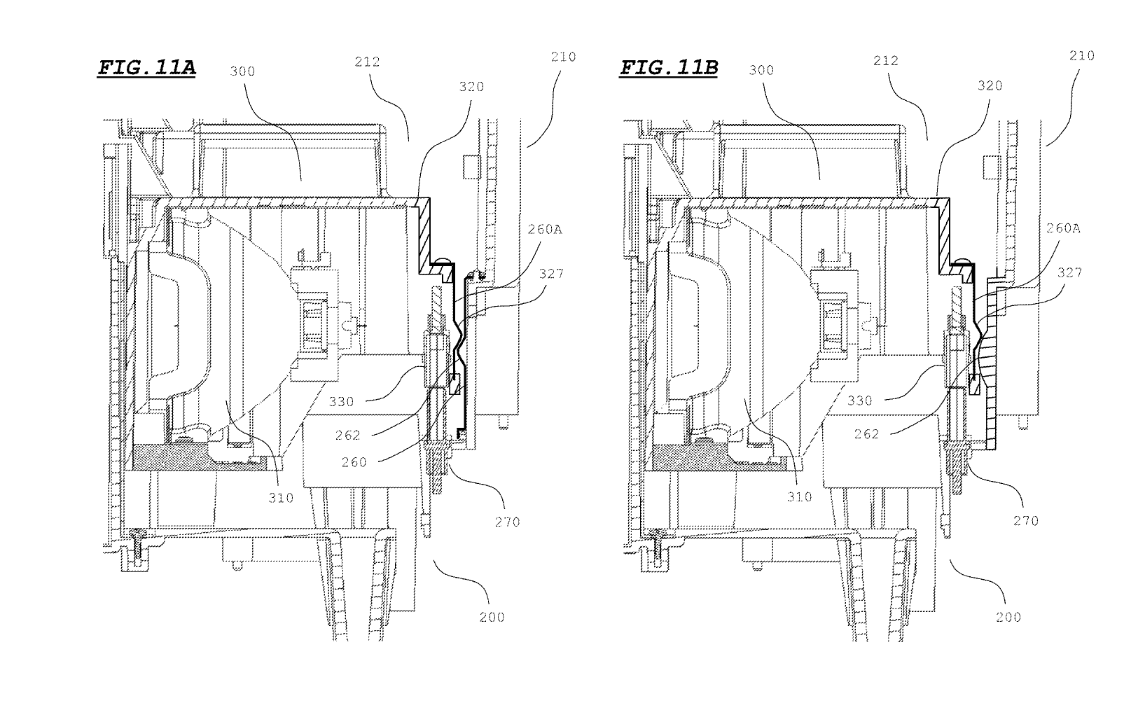

In the foregoing embodiment, for example, the second projection parts 262 are formed at plate springs 260 on the lamp attachment units 200. Alternatively, the first projection parts 327 may also be formed at plate springs 260A, and the plate springs 260A may be attached to the lamp holders 320, as shown in FIG. 11A. In this case, the first projection parts 327 may be formed in the triangle shape as with the second projection parts 262, so that the plate springs 260 can be easily folded to form the first projection parts 327. Further, as shown in FIG. 11B, the second projection parts 262 may be formed directly at housings 210, and the first projection parts 327 may be formed at the plate springs 260A attached to the lamp holders 320. In this case, the second projection parts 262 are formed in the shape of an arc, and the first projection parts 327 may be formed in the triangle shape.

In addition, in the foregoing embodiment, the second projection parts 262 are elastically held by the metal plate springs 260. However, the present invention is not limited to this but the second projection parts 262 may be elastically held by resin plate springs, for example. In this case, the resin plate springs may be integrated with the housings 210 (lamp storage parts 212) or may be formed as separate components. In addition, the second projection parts 262 may be elastically held by elastic members other than plate springs, for example, coil springs. This respect also applies to the case where the first projection parts 327 are elastically held as with the embodiment shown in FIGS. 11A and 11B.

Further, in the foregoing embodiment, the first projection parts 327 are formed in the shape of an arc. Alternatively, the first projection parts 327 may be formed in another shape, for example, the triangle shape. In this case, however, the first projection parts 327 need a larger force to go over the peak portions of the second parts 262, as compared with the case where the first projection parts 327 are formed in the shape of an arc, whereby the lamp units 300 may be slightly harder to attach.

Moreover, in the foregoing embodiment, light emitted from the lamp units 300 is reflected by the mirror members 220 (plane mirrors 222) for combination. Alternatively, the light combining part may use prisms, not mirrors as described above.

In addition, in the foregoing embodiment, the light source device 10 is formed by the lamp units 300 using lamp light sources. Alternatively, the light source device 10 may be formed by light source units using LED light sources or laser light sources.

Further, although the projector in the foregoing embodiment is a four-lamp projector, the projector may be a multi-lamp projector other than a four-lamp type, or may be a single-lamp projector.

Besides, the embodiment of the invention may be changed or modified as appropriate in various manners as necessary, within the scope of technical ideas in the claims.

What is claimed is:

1. A projection display device, comprising:
a light source part;
a light modulating part which modulates light emitted from the light source part;
an attachment part to which the light source part is attached; and
a power source part which supplies electric power to the light source part, wherein
the light source part includes a luminous body and a holder holding the luminous body,
the holder is provided with a first connector electrically connected to the luminous body,
the attachment part is provided with a second connector electrically connected to the power source part, and
an assist part is provided between the light source part and the attachment part so as to, when the light source part is attached to the attachment part, add a force to the light source part in a direction of attachment and thereby assist connection between the first connector and the second connector.

2. The projection display device according to Claim wherein
the attachment part includes a side surface which becomes opposite to a side surface of the holder when the light source part is attached therein,
the assist part includes a first projection part which is disposed on one of a side surface of the attachment part and a side surface of the holder; and a second projection part which is disposed on the other side surface and is brought into contact with the first projection part when the light source part is attached in the attachment part,
at attachment of the light source part in the attachment part, when the second projection part is pressed and elastically deformed by the first projection part and the first projection part goes over a peak portion of the second projection part, the light source part is biased in a direction of attachment by an elastic return force of the second projection part.

3. The projection display device according to claim 2, wherein
at least the second projection part is provided at a plate spring disposed on the side surface corresponding to the second projection part.

4. The projection display device according to claim 3, wherein
the plate spring with the second projection part is disposed on the side surface of the attachment part.

5. The projection display device according to claim 3, wherein
the first projection part is formed in the shape of an arc.

6. The projection display device according to claim 1, comprising:
a plurality of the attachment parts, a plurality of the light source parts attached to the attachment parts, and a light combination part combining light from the light source parts.
